(19) United States
(12) Patent Application Publication
(10) Pub. No.: US 2019/0294713 A1
(43) Pub. Date: Sep. 26, 2019

(54) DATABASE IMPACT ANALYSIS

(71) Applicant: Accenture Global Solutions Limited, Dublin (IE)

(72) Inventor: Siddharth Suri, Irvine, CA (US)

(21) Appl. No.: 15/928,361

(22) Filed: Mar. 22, 2018

(51) Int. Cl. G06F 17/30

(52) U.S. Cl. CPC G06F 17/30454; G06F 17/30554; G06F 17/30339

(57) ABSTRACT

Methods, systems, and apparatus, including computer programs encoded on a computer storage medium, for analyzing impact of a computer-readable code on a database are enclosed. In some implementations, actions include: receiving a computer-readable code from a computing device, determining one or more logical sets based on one or more database functions, identifying one or more table names in the one or more logical sets, the one or more table names being identified based on at least one database function that is set as a table identifier, the table names referring to respective tables in the database, providing a list of table names comprising one or more of the table names, and transmitting the list of table names to the computing device for display to a user.

### BACKGROUND

Software applications can perform multiple queries on data stored in a database. In some instances, a database can store hundreds, or thousands of terabytes of data. Databases can be organized in tables, and data is stored in fields within the tables. Queries issued by an application can impact particular tables, fields of tables, or particular sections of the fields. An application can include thousands of lines of code, among which hundreds of lines include instructions to query the database.

A problem arises when the application is modified. For example, an application can be modified, which results in a change in data formats. This can have a significant impact on the database. For example, a data format can change a type of data (e.g., character, Boolean, integer, decimal, real), and/or a parameter of the data (e.g., length). As one non-limiting example, a name can be of a character data type, and a length of ten (10) characters. However, a change can be implemented, which changes the name to twenty (20) characters. Consequently, the data stored in the database needs to be updated to reflect this change. It needs to be determined, however, which tables, and fields of the database are impacted by changes in the application. Going through the whole code base of the application to detect the impact on the database, is inefficient, and can be very resource consuming. Further, it can occur that a human-based review of the code introduces errors. These errors can result in downstream inefficiencies including inefficient use of computing resources (e.g., processors, memory).

### SUMMARY

Implementations of the present disclosure are generally directed to a computer-implemented database impact analysis platform. More particularly, implementations of the present disclosure are directed to analyzing an impact that an application issuing multiple queries to a database has on the database.

In some implementations, actions include receiving a computer-readable code from a computing device, determining one or more logical sets based on one or more database functions, each of the one or more logical sets including at least one of the one or more database functions, identifying one or more table names in the one or more logical sets, the one or more table names being identified based on at least one database function that is set as a table identifier, the table names referring to respective tables in the database, providing a list of table names comprising one or more of the table names, and transmitting the list of table names to the computing device for display to a user. Other implementations of this aspect include corresponding systems, apparatus, and computer programs, configured to perform the actions of the methods, encoded on computer storage devices.

These and other implementations can each optionally include one or more of the following features: the one or more database functions comprises at least one of select, from, order by, group by, as, and with; actions further include: determining that at least one table name of the one or more table names has one or more aliases in the computer-readable code, and replacing the one or more aliases with the at least one table name; the at least one database function that is set as a table identifier includes from; actions further include: identifying one or more columns in the one or more logical sets, the one or more columns being identified based on the one or more table names and one or more field-identifier database functions; the one or more field-identifier database functions include at least one of and, and where; actions further include: determining one or more subqueries from the one or more logical sets, wherein the one or more subqueries are determined based on the one or more database functions.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example high-level architecture in accordance with implementations of the present disclosure.

FIG. 2 depicts an example screen-shot in accordance with implementations of the present disclosure.

FIG. 3 depicts another example screen-shot in accordance with implementations of the present disclosure.

FIG. 4 depicts an example process that can be executed in accordance with implementations of the present disclosure.

### DETAILED DESCRIPTION

Implementations of the present disclosure are generally directed to a computer-implemented database impact analysis platform. More particularly, implementations of the present disclosure are directed to analyzing an impact that an application querying a database has on the database. In general, and as described in further detail herein, the impact represents the extent to which queries of the application pull data from tables, and particular fields of tables stored within the database. For example, the impact can be represented by a number of tables, specific tables, and fields of tables storing data requested by queries of the application. In some examples, the database impact analysis platform of the present disclosure eases the burden of analyzing applications querying a database, and enables applications to be revised to enhance resource-efficiency in database querying. Implementations of the present disclosure further enable tables, and fields within tables of the database to be identified to implement any required changes (e.g., changes to data type, and/or data parameters).

As described in further detail herein, implementations of the present disclosure may include actions of receiving a computer-readable code from a computing device, determining one or more logical sets based on one or more database functions, each of the one or more logical sets including at least one of the one or more database functions, identifying one or more table names in the one or more logical sets, the one or more table names being identified based on at least one database function that is set as a table identifier, the table names referring to respective tables in the database, providing a list of table names comprising one or more of the table names, and transmitting the list of table names to the computing device for display to a user.

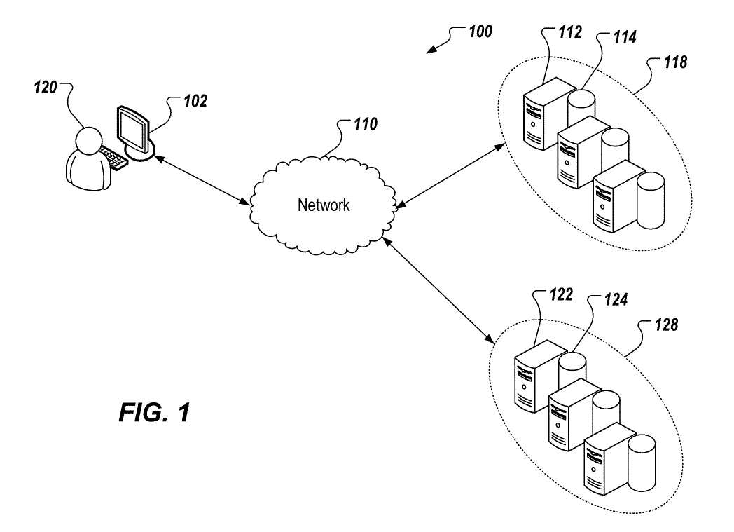

FIG. 1 depicts an example high-level architecture 100 in accordance with implementations of the present disclosure. The example architecture 100 includes a device 102, a back-end system 118, and a network 110. In some examples, the network 110 includes a local area network (LAN), wide area network (WAN), the Internet, a cellular telephone network, a public switched telephone network (PSTN), a private branch exchange (PBX), or any appropriate combination thereof, and connects web sites, devices (e.g., the device 102), and back-end systems (e.g., the back-end system 118). In some examples, the network 110 can be accessed over a wired and/or a wireless communications link. For example, mobile devices, such as smartphones can utilize a cellular network to access the network 110.

In the depicted example, the back-end system 118 includes at least one server system 112, and data store 114 (e.g., database). In some examples, one or more of the back-end systems host one or more computer-implemented services that users can interact with using computing devices. For example, and as described in further detail herein, the at least one database 114 can store data that users, and/or applications can interact with using computing devices. In some implementations, the back-end system 118 represents computer systems utilizing clustered computers and components to act as a single pool of seamless resources when accessed through a network. For example, such implementations may be used in data center, cloud computing, storage area network (SAN), and network attached storage (NAS) applications. In some implementations, back-end system 108 represents a virtual machine.

In some implementations, the computing device 102 can include any appropriate type of computing device such as a desktop computer, a laptop computer, a handheld computer, a tablet computer, a personal digital assistant (PDA), a cellular telephone, a network appliance, a camera, a smartphone, a telephone, a mobile phone, an enhanced general packet radio service (EGPRS) mobile phone, a media player, a navigation device, an email device, a game console, or an appropriate combination of any two or more of these devices, or other data processing devices.

In the depicted example, the computing device 102 is used by a user 120. In accordance with the present disclosure, the user 120 uses the device 102 to interact with the back-end system 118. In some examples, the user 120 can include a customer of an enterprise that has access to the database 114. For example, the user 120 can include a customer that communicates with the enterprise through one or more channels using the device 102. The user 120 can interact with the back-end system 118, for example, through respective graphical user interfaces (GUIs), which enable selection of data sources, computer codes, and tasks to be performed among other functions. In accordance with implementations of the present disclosure, and as described in further detail herein, the user 120 can use the database impact analysis platform to determine an extent to which an application querying data within the database 114 impacts the database 114.

Implementations of the present disclosure are described in further detail herein with reference to an example context. The example context includes a database storing data representing personnel of a company with tables associated with the offices of the company. The example context also includes SQL queries. The example queries may be a part of code underlying an application, which queries the database. It is contemplated, however, that implementations of the present disclosure can be realized in any appropriate context.

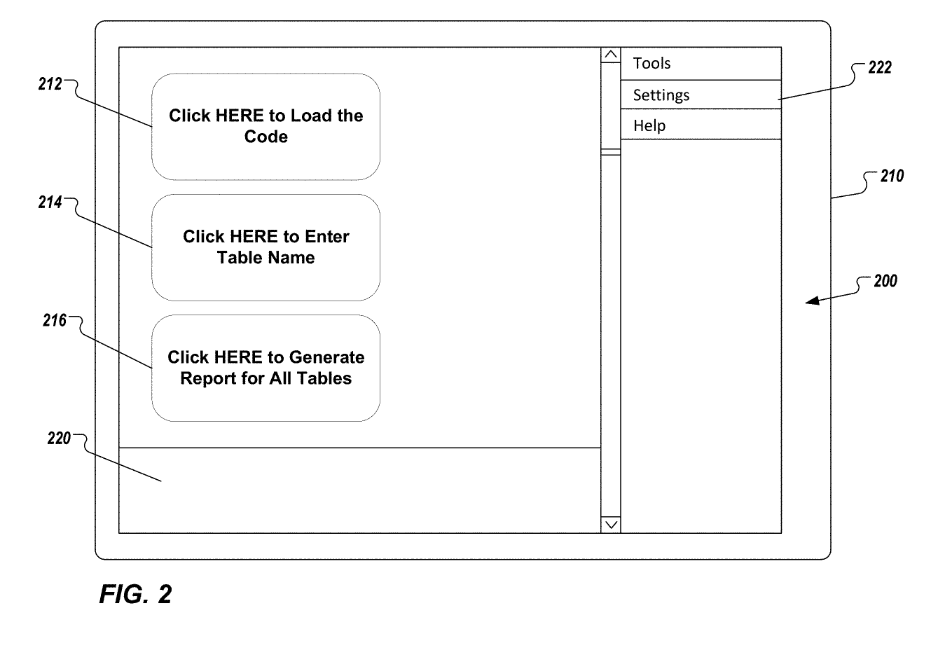

FIG. 2 depicts an example screen-shot in accordance with implementations of the present disclosure. The example screen-shot includes a graphical user interface (GUI) 200 provided by the database impact analysis platform. In some examples, the user interacts with the database impact analysis platform through the GUI 200. In some examples, the GUI 200 can be displayed in a display of a computing device (e.g., the computing device 102).

In the depicted example, the GUI 200 includes one or more interface elements 212, 214, 216. In some examples, the user can select code (e.g., computer code including queries) by clicking on the interface element 212. In one example, the code may be selected from a list of the code files stored either on a computing device (e.g. the device 102), or on a remote storage (e.g., in the back-end system 118). In another example, the code may be copied and pasted in a designated location in the GUI 200. For example, the code may be pasted into a dialog box 220, or in a pop up window that opens after clicking on the interface element 212.

In some implementations, the selected code can include one or more computer-executable instructions. In accordance with implementations of the present disclosure, the code may include one or more queries that are to be executed to query one or more databases. The code may be in a query language. Example query languages include, without limitation, Structured Query Language (SQL), Hive Query Language (HQL), Graph Query Language (GraphQL), PostgreSQL. It is contemplated that implementations of the present disclosure can be applicable with any appropriate query language. In some examples, the code can be stored in a computer-readable file (e.g., Extensible Markup Language (XML) file, text file).

In some implementations, there may be more than one database (e.g. database 114) with which the computing device 102 interacts. In some implementations, the user may have the option of selecting the database that is to be analyzed. For example, the GUI 200 may have a database selection element (not shown) for selecting one or more databases that are to be analyzed. In some implementations, the back-end system 118 may notify the computing device 102 of only the databases that have been enhanced. For example, either the computing device 102, the server system 112, or a third system (not shown) may notify the computing device 102 as to which databases have a change (e.g., change in data format, and/or parameter).

In some implementations, the user may choose the scope of analysis. In the depicted example, the user may click on an interface element 216 to receive all tables of the database that the code is to query. In some implementations, the user may select only particular table names, for example by selecting an interface element 214. As a result, the platform of the present disclosure may generate only the fields (e.g. columns) of the selected tables. In some implementations, a default setting of the platform may be to generate a report for all tables. In some implementations, the user may change the settings of the platform (e.g. by selecting setting menu 222) to analyze the code only for particular tables. In some implementations, the user may select particular field names (not shown in the figure) to receive a list of table names that cover the selected fields, in the code.

To further illustrate implementations of the present disclosure, a portion of example code is described. It is contemplated that implementations of the present disclosure can be used with any appropriate code. A sample portion of code (e.g. a query language code) is provided as:

Example Code Portion

select

OFFICE.OFFICE_NUM,
OFFICE.OFFICE_NAME,

(select CD.SHORT_ NAME from OFFICE_MASTER CD, OFFICE OFC

where CD.OFFICE_ID = OFC.id

and CD.TYPE_CODE=OFC.KEY_IDENTIF
and CD.CATGRY_ID=123

) as “OFFICE TYPE”,

PERS.LAST_NAME as “PARTICIPANT LAST NAME” ,
PERS.FIRST_NAME as “PARTICIPANT FIRST NAME”

FROM OFFICE, PERS

where OFFICE.id=Pers.OFFICE_ID

In some implementations, the code is processed to provide logical sets. In some examples, the logical sets are identified based on a list of logical-set-identifier (LSI) database functions. In some examples, a default list of the LSI database functions is provided. In some examples, a user may change, remove, or add database functions to the LSI list. In some examples, each LSI database function may identify a logical set. In some examples, a logical set may be identified if it includes a set LSI database functions. In some implementations, the logical sets are identified based on structure/syntax of the code (e.g. braces, brackets, etc.). Example LSI database functions can include, without limitation, select, from, order by, group by, as, and with. Accordingly, the code is processed to provide one or more logical sets (e.g., LS1, . . . , LSn).

In some implementations, each logical set is processed to identify one or more sub-queries. In some examples, sub-queries may be identified based on one or more sub-query-identifier (SQI) database functions. In some implementations, the list of SQI database functions may include one or more of the LSI database functions. For example, a sub-query can be considered as a logical sub-set within a logical set. In some implementations, the platform may have a default list of the SQI database functions. In some implementations, a user may change, remove, or add database functions to the list. In some examples, each SQI database function may identify a sub-query. In some examples, a sub-query may be identified by a set of SQI database functions. In some implementations, the sub-queries are identified based on structure/syntax of the code (e.g., braces, brackets, etc.). Accordingly, the code is processed to provide one or more sub-queries (e.g., SQ1, . . . , SQn).

In accordance with implementations of the present disclosure, each of the sub-queries is executed to identify distinct table names, and columns that are impacted by the sub-queries (e.g., tables, and columns, from which data is requested). In some examples, for each sub-query, a temporary data set is provided, in which the tables and columns for the respective sub-query are stored. Consequently, for multiple sub-queries, multiple temporary data sets are provided, one for each sub-query.

In some implementations, an output data set is provided based on the one or more temporary data sets. In some examples, the temporary data sets are compared to determine unique table names, and column names across all temporary data sets, and redundant table names and column names are removed. In this manner, the output data set includes only unique table names and column names.

In some implementations, a table name can be provided as a so-called alias. For example, a table may be corresponding to one or more aliases in the computer code. In the example code above, the table OFFICE_MASTER has alias CD, and the table OFFICE has alias OFC. In accordance with implementations of the present disclosure, an alias can be changed to the underlying table name. In some examples, the computer code is reformed by replacing the aliases with the underlying table name. For example, replacing the aliases with the underlying table names in the above example reforms the code to:

Revised Example Code Portion

select

OFFICE.OFFICE_NUM,
OFFICE.OFFICE_NAME,

(select OFFICE_MASTER.SHORT_ NAME from OFFICE_MASTER, OFFICE

where OFFICE_MASTER.OFFICE_ID = OFFICE.id

and OFFICE_MASTER.TYPE_CODE= OFFICE.KEY_IDENTIF
and OFFICE_MASTER.CATGRY_ID=123

) as “OFFICE TYPE”,

PERS.LAST_NAME as “PARTICIPANT LAST NAME” ,
PERS.FIRST_NAME as “PARTICIPANT FIRST NAME”

FROM OFFICE, PERS

where OFFICE.id=Pers.OFFICE_ID

In some implementations, the output data set can be filtered to provide a filtered output data set. In some examples, the output data set can be filtered based on the input provided by the user. For example, the user can provide input indicating table names, and/or column names that are to be filtered from the output data set (e.g., the user is not interested in the user-provided table names, and/or column names). As another example, the user can provide input indicating table names, and/or column names that are of interest, and any other table names, and/or column names can be filtered from the output data set (e.g., the user is only interested in the user-provided tables names, and/or column names).

Referring to the example code above, a first logical set (Logical Set 1 (LS1)) is provided as:

Example LSI

select
OFFICE.OFFICE_NUM,
OFFICE.OFFICE_NAME,

(select CD.SHORT_ NAME from OFFICE_MASTER CD, OFFICE OFC

where CD.OFFICE_ID = OFC.id

and CD.TYPE_CODE=OFC.KEY_IDENTIF
and CD.CATGRY_ID=123

) as “OFFICE TYPE”,

```
PERS.LAST_NAME as “PARTICIPANT LAST NAME” ,
PERS.FIRST_NAME as “PARTICIPANT FIRST NAME”
  FROM OFFICE, PERS
  where OFFICE.id=PERS.OFFICE_ID
```

Because the example code is a relatively simple example, only a single logical set is provided (e.g., n=1).

In some implementations, one or more sub-queries are provided from the logical sets by applying SQ1 database function(s). Continuing with the example LS1 provided above, an example sub-query (Sub-Query 1 (SQ1)) may be provided as:

Example SQ1

(select CD.SHORT_ NAME from OFFICE_MASTER CD, OFFICE OFC

where CD.OFFICE_ID = OFC.id

and CD.TYPE_CODE=OFC.KEY_IDENTIF
and CD.CATGRY_ID=123

) as “OFFICE TYPE”,

Because the example code is a relatively simple example, only a single sub-query is provided (e.g., m=1).

Continuing with the example code above, table names may be identified by table identifier from, and column names may be identified by field identifiers and where. Accordingly, the following lists of table names and field names can be provided for the example sub-query, SQ1:

List of Table Names: OFFICE_MASTER; OFFICE; OFFICE; PERS
List of Column Names: OFFICE.OFFICE_NUM; OFFICE.OFFICE_NAME;

```
  CD.SHORT_NAME; CD.OFFICE_ID; OFC.id;
  CD.TYPE_CODE; OFC.KEY_IDENTIF; CD.CATGRY_ID;
  PERS.LAST_NAME; PERS.FIRST_NAME; PERS.OFFICE_ID
```

As described above, any alias used for a table name, and/or a column name is replaced with the actual name. Further, any redundant table names, and/or column names are removed.

Accordingly, the following example output data set can be provided based on the above examples:

List of Table Names:
OFFICE MASTER
OFFICE
PERS

List of Field Names:
OFFICE. OFFICE_NUM;
OFFICE. OFFICE_NAME;
OFFICE_MASTER. OFFICE_ID;
OFFICE_MASTER. SHORT_NAME;
OFFICE_MASTER. TYPE_CODE;
OFFICE_MASTER.CATGRY_ID
OFFICE.ID
OFFICE. KEY_IDENTIF
PERS.OFFICE_ID
PERS.LAST_NAME

In some implementations, the platform may transmit the lists of table names and column names to the computing device 102, and/or a third-party computing device. The computing device may present the lists to a user (e.g. user 120) or may further process, analyze, or transmit the lists. In some implementations, the platform may transmit the lists to a server (for example server 112 or 122) for further analysis, process, or transmission to other servers or computer devices. In some implementations the lists may be stored in a data storage (e.g. a database 124 or a data storage at the computing device 102). In some implementations, the lists may be presented, imported, or stored in Microsoft Excel, TEXT, XML, or in any other textual data format.

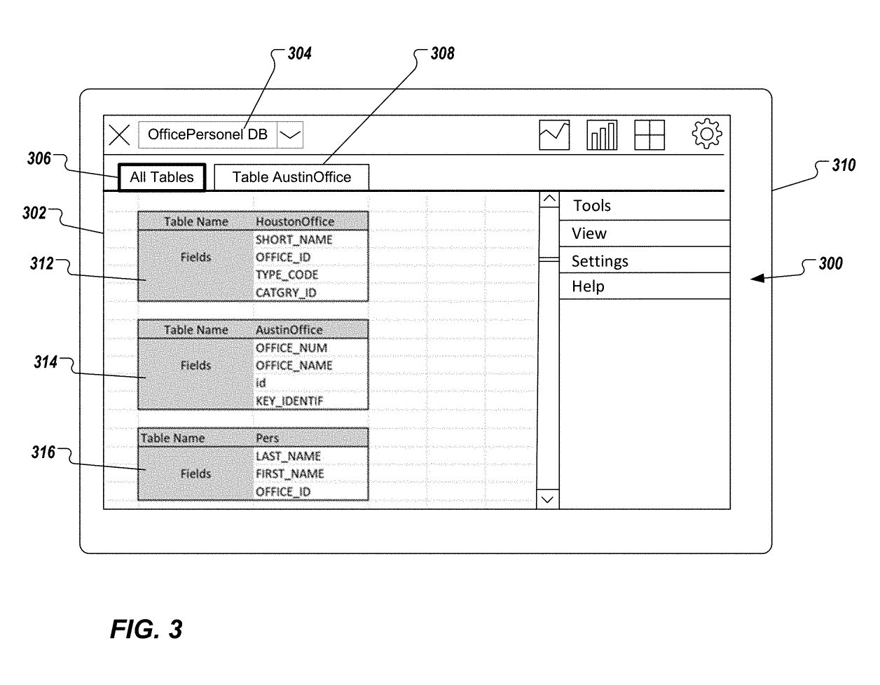

FIG. 3 depicts an example screen shot in accordance with implementations of the present disclosure. The example screen shot includes a GUI 300 to present the result of the tool's analysis (e.g. the table and field lists). In some examples, the GUI 300 can be displayed in a display of a computing device 310 (e.g., the computing device 102). In some examples the GUI 300 may use the same computing device (computing device 210) as the GUI 200 does.

In the depicted example, GUI 300 represents the tool's analysis of the example code in data frame 302. Data frame 302 includes tables 312, 314, and 316. Tables 312, 314, and 316 represent OfficePersonel database's tables and fields that the example code impacts. In some examples, databases may be selected before the tool has initiated. Alternatively, the tool may scan the code to detect with what databases the code communicates. In some implementations, the tool may run on a code for more than one database. In these implementations, the user may have the option of selecting the databases to be presented in GUI 300. In the depicted example, the user may select the database from a user interface 304. The user interface 304 in this example is provided as a drop-down menu that includes a list of databases.

Additionally, the GUI 300 may provide one or more indicators that indicate a scope of the tool's analysis. In the depicted example, indicators 306 and 308 determine the scope of analysis the data frame 302 presents. Indicator 306 indicates presentation of all the impacted tables and fields. Indicator 308 indicates presentation of the impacted fields of table OFFICE. There can be another indicator 318 (not shown) indicating presentation of the impacted tables that include a particular field name. In some implementations, presentation of the indicators depends on the actions that the user had taken in GUI 200.

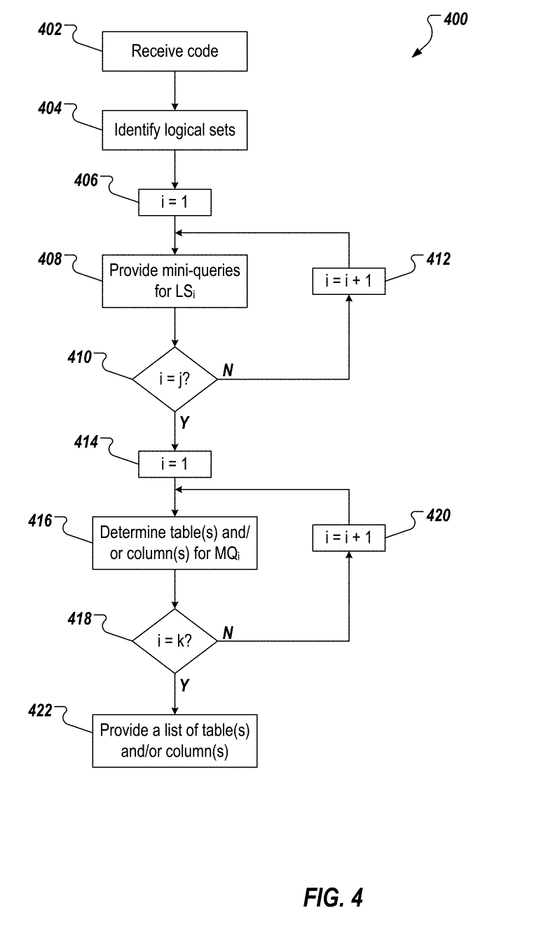

FIG. 4 depicts an example process 400 that can be executed in implementations of the present disclosure. In some examples, the example process 400 is provided using one or more computer-executable programs executed by one or more computing devices (e.g., the back-end system 118, and/or the computing device 102 of FIG. 1).

Computer code is received (402). In some examples, the computer code is provided as a computer-readable file (e.g., XML file, TXT file). The computer code includes one or more queries that are executed to query a database (e.g., the database 114 of FIG. 1). For example, the code may be received at the computing device 102 (e.g. by selecting the load interface element 212). The code may be stored in the computing device 102, or on another computing device connected to the computing device 102 by the network 110, or on a server system (e.g. server system 112, 122) that is connected to the device 102 by the network 110.

Logical sets are identified (404). In some implementations, the logical sets are identified based on one or more database functions. In some implementations, the logical sets are identified based on braces/brackets. In some implementations, the code may include a plurality of logical sets (e.g., LS1, . . . , LSn).

A counter i is set equal to 1. One or more sub-queries are provided for LSᵢ (408). Sub-queries may be identified based on one or more database functions. It is determined whether i is equal to n (410). That is, it is determined whether all of the logical sets have been evaluated for sub-queries. If i is not equal to n, the counter i is incremented (412), and the example process 400 loops back.

If the counter i is equal to n, the counter i is set equal to 1 (414). Table names, and/or column names are determined for SQᵢ (416). It is determined whether i is equal to m (418). That is, it is determined whether all of the sub-queries have been evaluated for table names and column names. If i is not equal to m, the counter i is incremented (420), and the example process 400 loops back.

If the counter i is equal to m, a list of table(s), and/or a list of column(s) is provided (422). In some examples, the list of tables, and the list of column names is provided from temporary data sets, as described herein. In some examples, the list of tables, and the list of column names have any aliases changed to actual names, and have any redundant names removed. The lists may be transmitted to the computing device 102, to a server (e.g. server system 112), or to a third-party computing device. The list(s) may be presented to a user for example via GUI 300, or may be imported to another software for further analysis.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method for analyzing impact of a computer-readable code on a database, the method being executed by one or more processors and comprising:
receiving, by the one or more processors, the computer-readable code from a computing device;
determining, by the one or more processors, one or more logical sets based on one or more database functions, each of the one or more logical sets including at least one of the one or more database functions;
identifying, by the one or more processors, one or more table names in the one or more logical sets, the one or more table names being identified based on at least one database function that is set as a table identifier, the table names referring to respective tables in the database;
providing, by the one or more processors, a list of table names comprising one or more of the table names; and
transmitting, by the one or more processors, the list of table names to the computing device for display to a user.

2. The computer-implemented method of claim 1, wherein the one or more database functions comprises at least one of select, from, order by, group by, as, and with.

3. The computer-implemented method of claim 1, further comprising:
determining, by the one or more processors, that at least one table name of the one or more table names has one or more aliases in the computer-readable code; and
replacing, by the one or more processors, the one or more aliases with the at least one table name.

4. The computer-implemented method of claim 1, wherein the at least one database function that is set as the table identifier includes from.

5. The computer-implemented method of claim 1, further comprising identifying, by the one or more processors, one or more columns in the one or more logical sets, the one or more columns being identified based on the one or more table names and one or more field-identifier database functions.

6. The computer-implemented method of claim 5, wherein the one or more field-identifier database functions include at least one of and, and where.

7. The computer-implemented method of claim 1, further comprising determining, by the one or more processors, one or more subqueries from the one or more logical sets, wherein the one or more subqueries are determined based on the one or more database functions.

8. One or more non-transitory computer-readable storage media coupled to one or more processors and having instructions stored thereon which, when executed by the one or more processors, cause the one or more processors to perform operations for analyzing impact of a computer-readable code on a database, the operations comprising:
receiving the computer-readable code from a computing device;
determining one or more logical sets based on one or more database functions, each of the one or more logical sets including at least one of the one or more database functions;
identifying one or more table names in the one or more logical sets, the one or more table names being identified based on at least one database function that is set as a table identifier, the table names referring to respective tables in the database;
providing a list of table names comprising one or more of the table names; and
transmitting the list of table names to the computing device for display to a user.

9. The computer-readable storage media of claim 8, wherein the one or more database functions comprises at least one of select, from, order by, group by, as, and with.

10. The computer-readable storage media of claim 8, wherein the operations further comprise:
determining that at least one table name of the one or more table names has one or more aliases in the computer-readable code; and
replacing the one or more aliases with the at least one table name.

11. The computer-readable storage media of claim 8, wherein the at least one database function that is set as the table identifier includes from.

12. The computer-readable storage media of claim 8, wherein the operations further comprise identifying one or more columns in the one or more logical sets, the one or more columns being identified based on the one or more table names and one or more field-identifier database functions.

13. The computer-readable storage media of claim 12, wherein the one or more field-identifier database functions include at least one of and, and where.

14. The computer-readable storage media of claim 8, wherein the operations further comprise determining one or more subqueries from the one or more logical sets, wherein the one or more subqueries are determined based on the one or more database functions.

15. A system, comprising:
one or more processors; and
a computer-readable storage device coupled to the one or more processors and having instructions stored thereon which, when executed by the one or more processors, cause the one or more processors to perform operations for analyzing impact of a computer-readable code on a database, the operations comprising:
receiving the computer-readable code from a computing device;
determining one or more logical sets based on one or more database functions, each of the one or more logical sets including at least one of the one or more database functions;
identifying one or more table names in the one or more logical sets, the one or more table names being identified based on at least one database function that is set as a table identifier, the table names referring to respective tables in the database;
providing a list of table names comprising one or more of the table names; and
transmitting the list of table names to the computing device for display to a user.

16. The system of claim 15, wherein the one or more database functions comprises at least one of select, from, order by, group by, as, and with.

17. The system of claim 15, wherein the operations further comprise:
determining that at least one table name of the one or more table names has one or more aliases in the computer-readable code; and
replacing the one or more aliases with the at least one table name.

18. The system of claim 15, wherein the at least one database function that is set as the table identifier includes from.

19. The system of claim 15, wherein the operations further comprise identifying one or more columns in the one or more logical sets, the one or more columns being identified based on the one or more table names and one or more field-identifier database functions.

20. The system of claim 19, wherein the one or more field-identifier database functions include at least one of and, and where.

21. The system of claim 15, wherein the operations further comprise determining one or more subqueries from the one or more logical sets, wherein the one or more subqueries are determined based on the one or more database functions.
